(19) United States
(12) Patent Application Publication
(10) Pub. No.: US 2011/0102460 A1
(43) Pub. Date: May 5, 2011

(54) PLATFORM FOR WIDESPREAD AUGMENTED REALITY AND 3D MAPPING

(76) Inventor: Jordan PARKER, Rochester, NY (US)

(21) Appl. No.: 12/939,663

(22) Filed: Nov. 4, 2010

Related U.S. Application Data
(60) Provisional application No. 61/258,041, filed on Nov. 4, 2009.

(51) Int. Cl. G09G 5/00; G06F 17/30

(52) U.S. Cl. 345/633; 707/803; 707/E17.044

(57) ABSTRACT

A client device sends the following data to the servers: still frames from captured video and in some embodiments other data such as GPS coordinates, compass reading, and accelerometer data. The servers break down each frame into feature points and match those feature points to existing point cloud data to determine client device's point of view (POV). The servers send the resulting information back to the client device, which uses the POV information to render augmentation content on a video stream. Information sent by client devices to the server can be used to augment the feature-point cloud.

### REFERENCE TO RELATED APPLICATION

The present application claims the benefit of U.S. Provisional Patent Application No. 61/258,041, filed Nov. 4, 2009, whose disclosure is hereby incorporated by reference in its entirety into the present disclosure.

### FIELD OF THE INVENTION

The present invention is directed to augmented reality and more particularly to augmented reality in which a viewing device is located in space and information is overlaid on an image formed by the viewing device using a feature-point cloud, and in which information received from the viewing device is used to update the feature-point cloud.

2. Description of Related Art

Augmented Reality (commonly shortened to “AR”) is a subset of virtual reality described as “a combination of real-world and computer-generated data, where computer graphics objects are blended into a user's view of reality in real time.” Augmented reality is actually a branch of virtual reality, the difference being that in virtual reality, the environment is entirely computer generated. A virtual-reality environment may even closely resemble a real-life scene, but all the actual image data is stored on the computer and has to be reconstructed from scratch. In augmented reality, the real-life environment surrounding the user is captured using an imaging device, processed, then combined with digital graphics in real time.

FIGS. 1a and 1b provide a visual comparison of virtual vs. augmented reality. FIG. 1a shows a screen shot 102 from the video game Second Life. Note that even though the environment resembles a life-like location and may even correspond to an actual place, a computer generates all of the graphics. By contrast, FIG. 1b shows a screen shot 104 of an augmented-reality environment. Digital information 106 is blended into an image 108 of a real scene (usually in real-time). That allows the viewer to quickly learn more about the environment around them and thus make more informed decisions.

As another example, FIG. 1c shows a screen shot from a televised football game. In the screen shot 110, a yellow first-down line 112 is superimposed on the field of view. An actual line 114 is also shown.

As yet another example, Topps Company, Inc., of New York, N.Y., has introduced a line of augmented-reality “Topps 3D Live” baseball cards, as described in the article “Webcam Brings 3-D to Topps Sports Cards,” The New York Times, Mar. 8, 2009. A collector who holds such a card in front of a webcam will see a three-dimensional avatar of the player on the computer screen. Rotation of the card causes the figure to rotate in full perspective. As seen in the screen shot 116 of FIG. 1d, the computer screen shows both the physical card 118 and the avatar 120.

The concept of augmented reality has existed in science fiction lore and in various areas of academic and industry research for decades. Popular conceptions of AR can be seen in the science-fiction film The Terminator (see FIGS. 2a and 2b) and in modern first-person shooter video games (see FIGS. 3a and 3b). In greater detail, FIGS. 2a and 2b show stills 202, 204 in which digital information 206, 208 is overlaid on images 210, 212. FIG. 3a shows a screen shot 302 of a first person shooter video game. The NSEW direction the player is facing is displayed in a HUD (heads-up display) 304 in the bottom right hand corner. FIG. 3b shows another screen shot 306 from the same game, in which the other players 308 have arrows 310 above their heads, allowing the player to make better real-time decisions.

Limited real-world examples of augmented-reality systems also exist. Fighter jets have been using an augmented reality HUD for many years now to give accurate, real-time navigation and targeting information. In greater detail, FIG. 4a shows a screen shot from an augmented-reality HUD in fighter jets. The display 402 gives the pilot real-time information 404 on his bearing, orientation relative to the horizon, and on other aircraft in his field of view 406. FIG. 4b is taken from the HUD recorder of an actual F18 in combat. Boeing has used AR HUD's to assist in the assembly of their aircraft since 1992.

There are large technical challenges to implementing any sort of functional AR system, and therefore, not many companies have pursued the development of commercial products for consumers. Any such system must include the following components:

A modern computing device with CPU, graphics output and data storage
Advanced computer vision and image processing algorithms
A digital imaging device (camera)
A display for blending computer and real-world images. This can be either in the form of a video screen that displays both types of graphics at once, or transparent display that allows the user to perceive the real world through the screen while simultaneously viewing the augmentations.

In order for any such system to be useful to humans, the image data must refresh at a reasonable rate (>10 Hz) and must include stereopsis (depth perception). Both must be present in order to create a believable augmented environment. An additional requirement for function systems is that the user must be able to move freely around his/her environment without restriction. Thus the main problem associated with useable AR systems, as stated in greater detail below, is in accurate recognition and tracking of real-world objects by a computer system.

The major obstacle to the implementation of any AR system is precisely locating the viewing device (usually a video camera) in 3-dimensional space by a computer system (referred to as “tracking”) and understanding the depth and shape of its immediate surroundings. If this task is accomplished, it is a fairly straightforward geometrical process to overlay new information precisely on top of the video feed.

There are a number of solutions currently being explored. The most common way is via pattern recognition. A small pattern of high-contrast shapes (markers) is arranged in a particular way such that the computer can recognize and lock onto the image, determining its position and orientation. While this method does allow for accurate tracking, it is impractical to deploy on a wide scale, say, for a city-wide AR system.

A second way uses feature-point analysis and requires no preset markers. An image from a video feed is analyzed, and specific points that are readily identifiable regardless of viewing angle are registered with the system. Once those feature points have been established, the computer uses those points to establish a coordinate system on which virtual objects can be superimposed. That method is superior to the marker method and has potential to become a universally applicable technology.

A third way to realize an AR system is from non-video tracking, using data from a compass, accelerometer, and/or location based triangulation system (like GPS). This method is useful in that it does not require costly computations to locate the user, but is inferior in that it is impossible to overly information in an extremely accurate manner with this type of tracking. Augmentations cannot account for skew from perspective, among other things.

Hybrid solutions are currently being used in some AR technologies that combine location-based data with markerless feature tracking.

### SUMMARY OF THE INVENTION

In view of the above, there exists a need to improve AR systems.

It is therefore an object of the invention to provide an AR system that takes into account current advances in computer processing power, mobile devices and wireless technology.

It is another object of the invention to provide an AR system that in some embodiments updates its feature-set database in accordance with information received from users.

To achieve the above and other objects, the present invention is directed to an AR system and method in which a client device such as a smart phone sends images and position data to servers. The servers break down each frame into feature points and match those feature points to existing point cloud data to determine the client device's point of view (POV). The servers send the resulting information back to the client device, which uses the POV information to render augmentation content on the video stream. Information sent by client devices to the server can be used to augment the feature-point cloud.

### BRIEF DESCRIPTION OF THE DRAWINGS

A preferred embodiment will be set forth with reference to the drawings, in which:

FIG. 1a shows a known virtual-reality environment;

FIG. 1b shows a known augmented-reality environment;

FIGS. 1c and 1d show other known examples of augmented reality;

FIGS. 2a and 2b show another known augmented-reality environment in a movie;

FIGS. 3a and 3b show another known augmented-reality environment in a video game;

FIGS. 4a and 4b show an augmented-reality HUD (heads-up display) in a fighter jet;

FIG. 5 shows a block diagram of a system on which the preferred embodiment can be implemented; and

FIGS. 6 and 7 are flow charts showing the operation of the preferred embodiment.

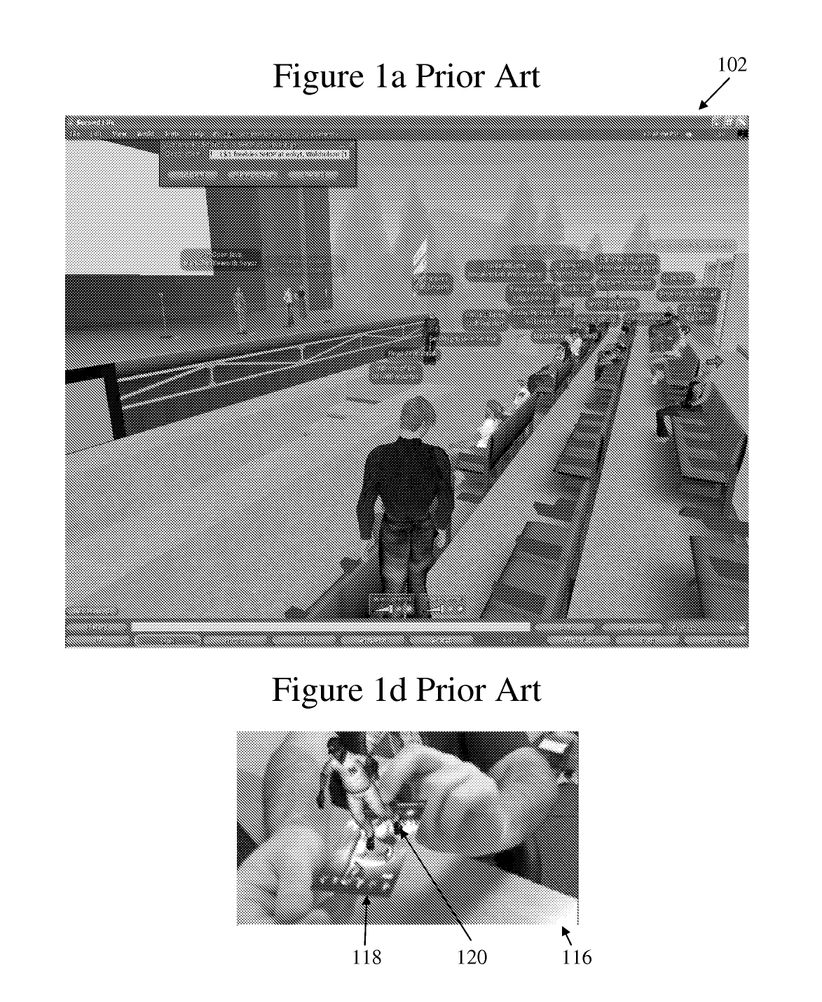

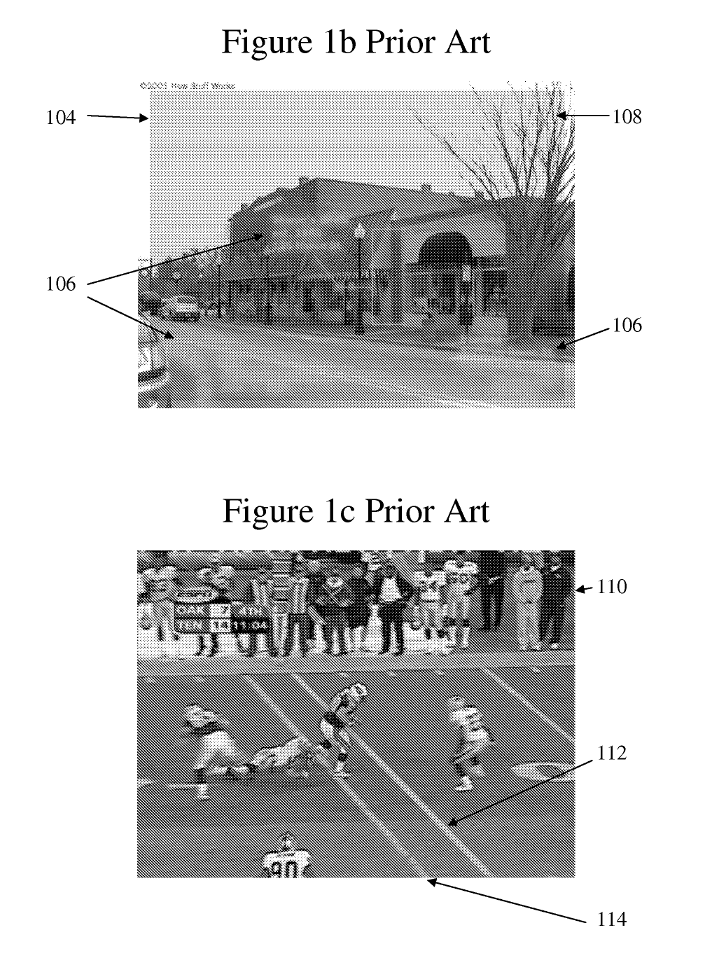

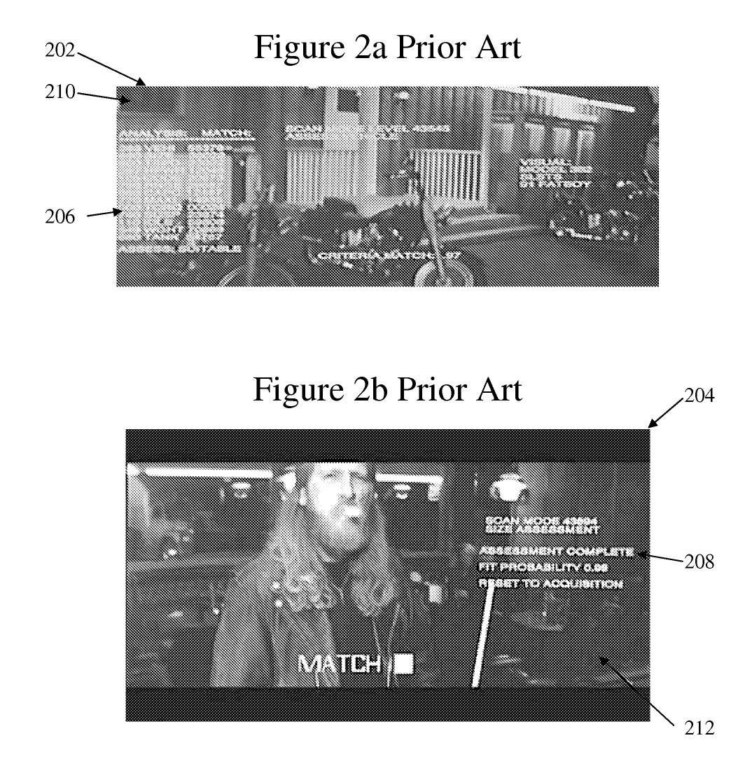

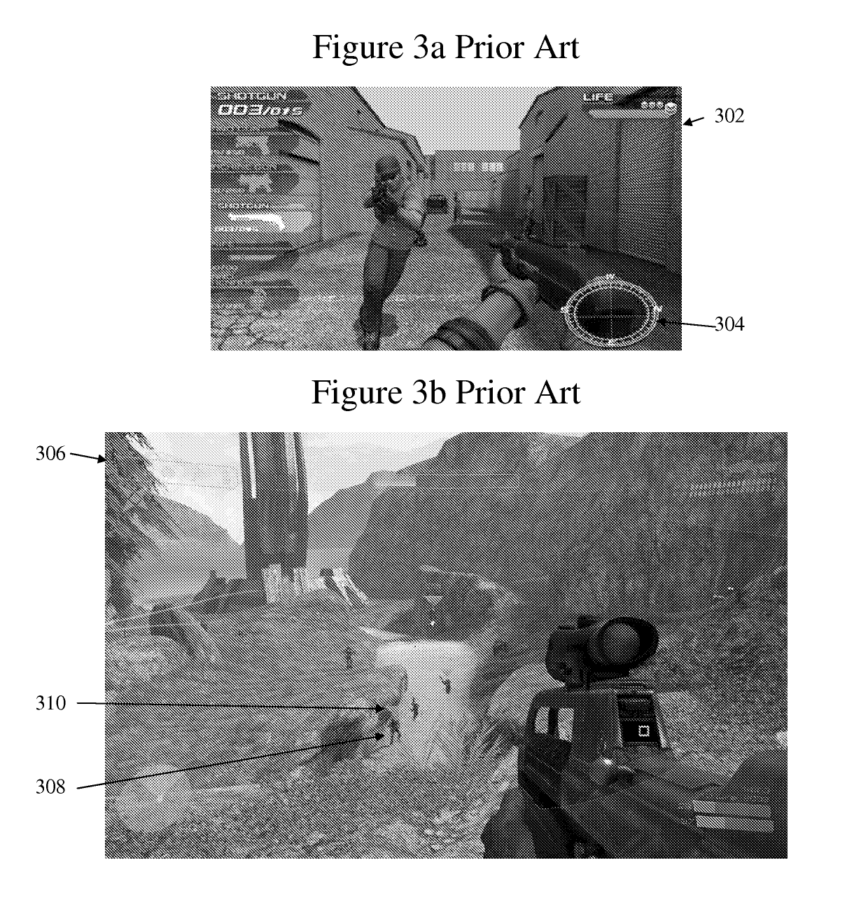

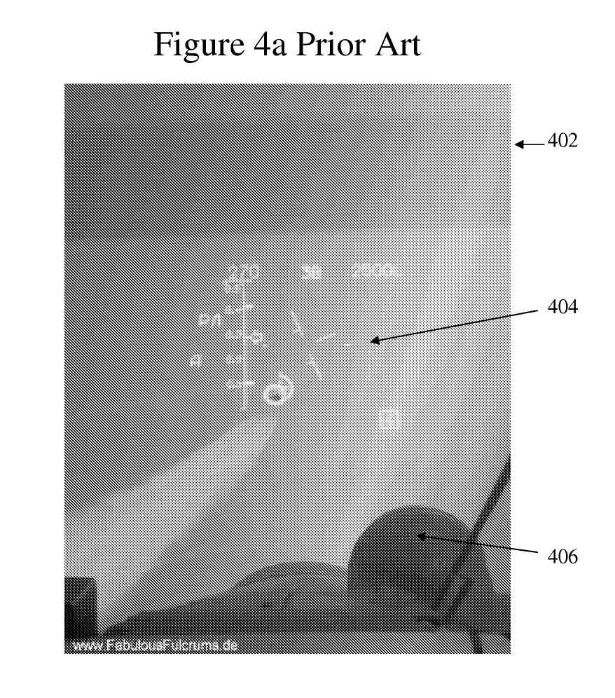

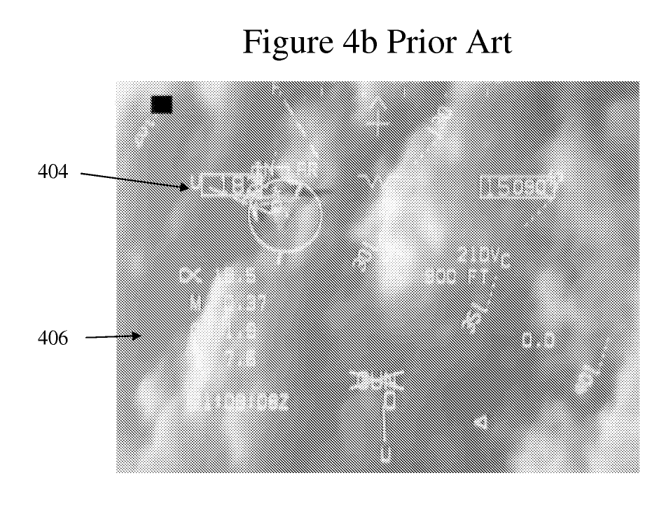

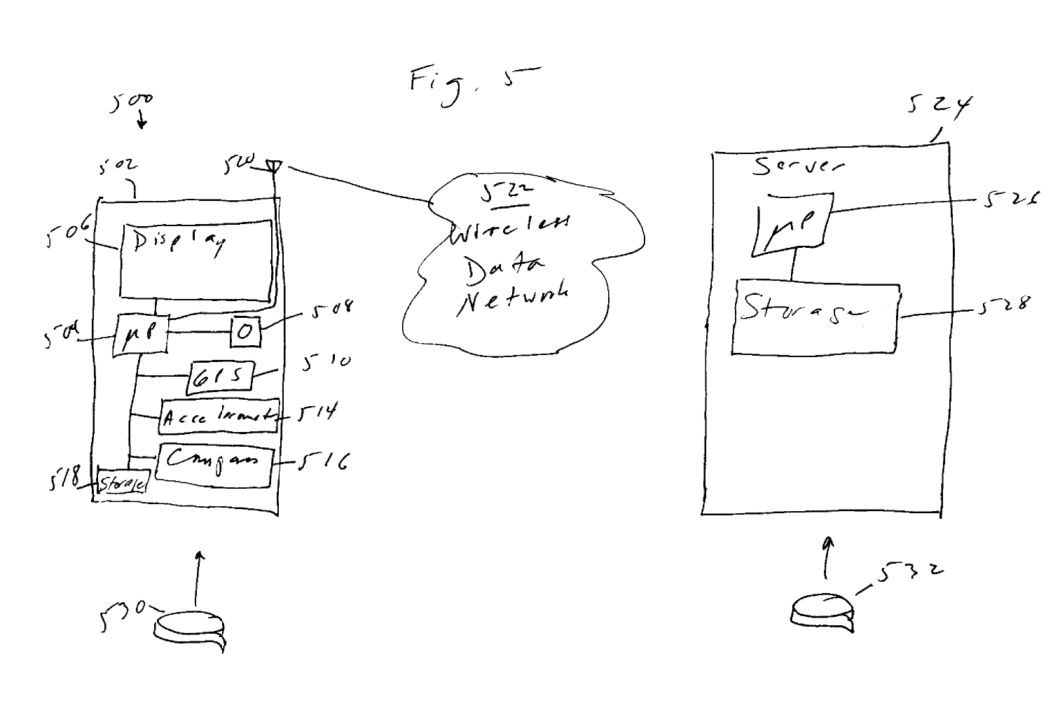

### DETAILED DESCRIPTION OF THE PREFERRED EMBODIMENT

A preferred embodiment of the present invention will be set forth in detail with reference to the drawings, in which like reference numerals refer to like elements or steps throughout.

First, hardware components for the preferred embodiment will be discussed. Components required for the preferred embodiment may or may not be required for other embodiments of the invention; therefore, indications of required hardware components should be understood as illustrative rather than limiting.

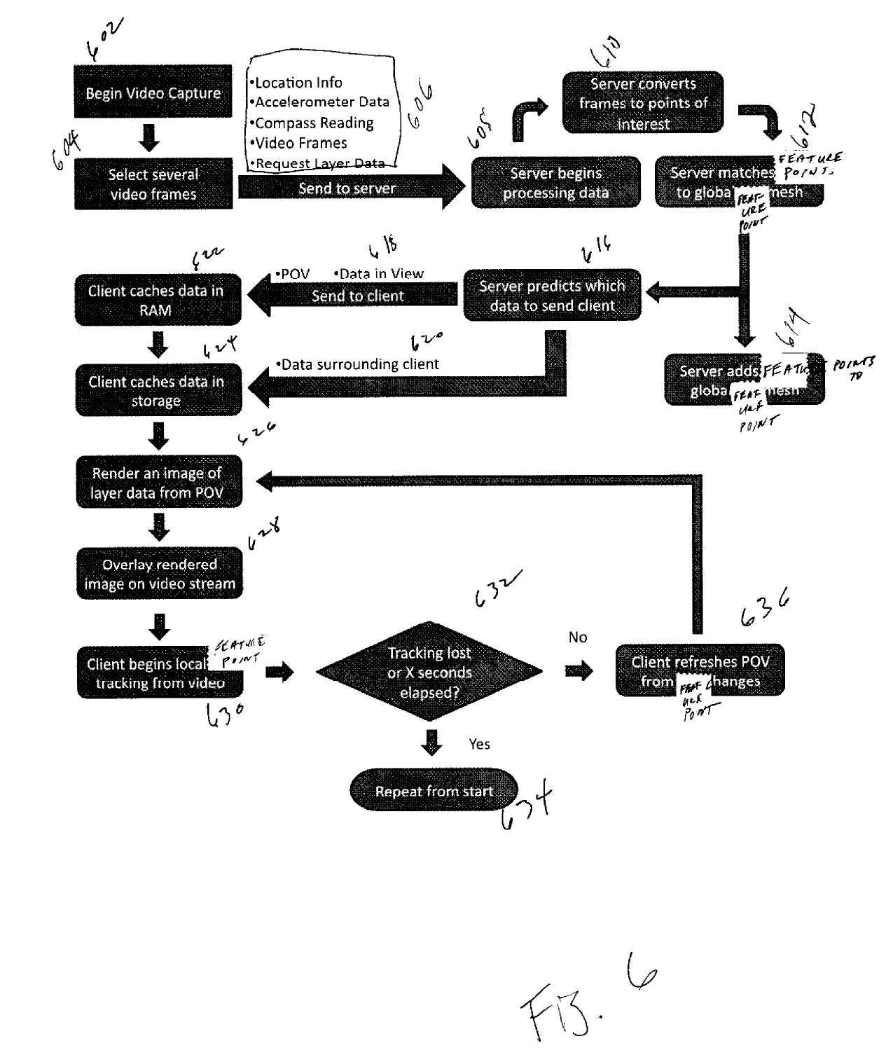

As shown in FIG. 5, a system 500 includes the following components:

1. A mobile computing host device 502 with at least:

a. A modern processor 504.

b. A display or video-out capability 506.

c. A camera 508.

d. A GPS receiver 510.

e. An accelerometer 514.

f. A compass 516.

g. A persistent storage 518 (e.g., non-removable persistent memory or micro-SDHC card) on which software, to be described below, is stored for execution by the processor 504.

h. A wireless data connection 520, e.g., a wireless 3G or 4G Internet connection or a WiFi connection.

Note that a modern smart phone fits this description. In the case of a smart phone which lacks an accelerometer, a compass, or both, the information may alternatively be determined, e.g., by determining changes in the data from the GPS receiver.

2. A wireless data network 522 such as 3G, 4G or WiFi covering the area to augment.

3. Servers 524 to store augmentation data and perform intensive calculations, the servers having processors 526 and persistent storage (e.g., hard drives or other storage media) 528 for storing the augmentation data and server-side software, to be described below.

The following software components are also required for the preferred embodiment:

1. Client Software.

a. A base program to access the host device's camera, GPS, and accelerometer, and to provide a graphic interface for the user.

b. Feature-point generating and tracking algorithm.

c. Data caching and retrieval system.

d. 3D rendering engine.

2. Server Software.

a. Algorithm to compare and merge feature points, generating a 3D feature-point cloud that reflects physical 3D structures.

b. Database management software.

c. Client-server interaction controller, including predictive algorithms for data caching.

The software can be provided to the hosts 502 and the servers 524 in any suitable manner, e.g., by physical storage media 530, 532 or by transmission.

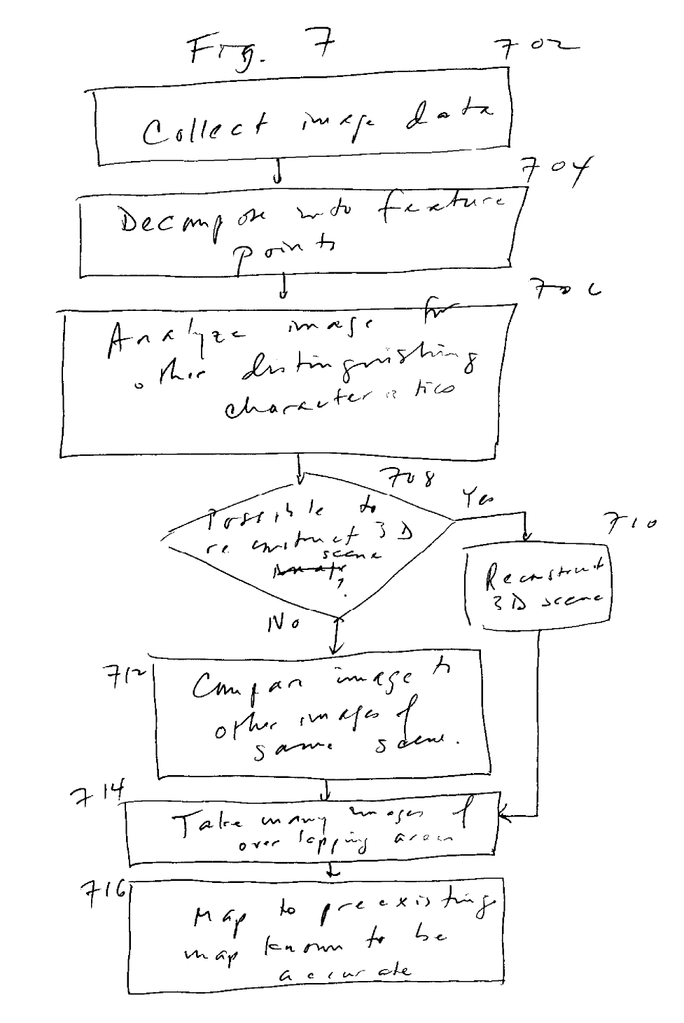

The hardware and software components interact in the following manner. Reference is made to the flow charts of FIGS. 6 and 7.

1. Start camera stream on client device (FIG. 6, step 602).

2. Determine which video frames are useful (not blurry) (step 604).

3. Client sends the following data to the servers (step 606):

a. GPS coordinates;

b. Compass reading;

c. Accelerometer data;

d. Still frames from captured video;

e. Requested augmentation content.

4. Servers process data (step 608).

a. Break down each frame into feature points using feature-point alignment algorithm (step 610).

b. Match feature points to existing feature-point cloud data to determine client device's point of view (POV) (step 612).

c. Server inserts new feature points into global 3D feature-point cloud, adding complexity and accuracy to the feature-point cloud (step 614).

5. Server intelligently sends data back to phone, predicting which data to cache on phone based on client's predicted motion (step 616), considering:

i. Line of sight;

ii. Traveling speed and direction;

iii. Relevancy of augmentation content.

a. Server sends data directly in POV first (step 618).

b. Server then sends data surrounding the client (step 620).

6. Client stores the POV data in a cache (step 622) and stores the surrounding data in storage (step 624).

7. Client device renders an image of the augmentation content data from the client device's POV (step 626) and uses POV information to render augmentation content on video stream (step 628).

a. Client stores a 3D model of the cached content info.

b. By rendering the 3D model from the client's POV, an accurate overlay is generated and added to the video stream.

8. Client begins local feature-point tracking to update POV in real time (step 630).

a. Creates local feature-point cloud.

b. Dumps mesh to server for assimilation with global feature-point cloud (if possible) otherwise dump images to server for same purpose.

9. If it is determined (step 632) that local tracking fails or if X seconds have elapsed, then repeat steps 602-630 to reacquire POV (step 634). Otherwise, the client device refreshes its POV from the feature-point changes (step 636).

10. If client adds content to environment, upload info to server (as explained below). The server then stores that info.

An important feature of the present invention is its ability to automatically and/or manually collect and store dense 3D data pertaining to physical locations (feature-point cloud). That occurs in the following manner:

1. Image data is collected from the imaging device (FIG. 7, step 702).

2. The image data is decomposed into feature points that can be easily tracked by a computer program as they translate in space or are viewed from different angles (step 704).

3. The image data may also be analyzed for other distinguishing characteristics that aid in 3D reconstruction, such as for edges, color gradients, surface textures, etc (step 706).

4. A 3D scene is reconstructed from the images if possible (steps 708 and 710). If not, the images are compared to other images of the same scene (perhaps from different angles) in order to aid in 3D reconstruction of the model (step 712).

5. Many images of overlapping areas are taken in the same manner as steps 702-712 (step 714). That allows the model to grow in area of coverage and complexity.

6. This model can be mapped to a pre-existing 2D or 3D map of the same scene known to be accurate in order to create a more advanced 3D model (step 716).

Novel characteristics of the invention not present in other AR systems are as follows. The following list should be taken as illustrative rather than limiting.

1. The tying of hardware and software together in the method outlined above into a single, unified system with many users.

2. The ability to dynamically aggregate feature-point data from many video feeds into a larger 3D point cloud.

3. The ability to map this data to digital representations of real physical objects and places (ex: mapping a point cloud gathered from video feeds to a 3D map of a city) for the purpose of providing augmentations on top of a video feed.

4. The ability for a 3D point cloud to update and/or improve its complexity and accuracy to reality from new user feeds, and the ability for the point cloud to expand the area of coverage from analyzing video feeds of previously unmapped areas.

5. The ability to use the mapping described in (3) to accurately introduce relevant augmentations onto the user's POV.

6. The treatment of this invention as a type of utility that others add value to by developing content.

Any suitable technique for feature detection can be used in the present invention. Such techniques are known in the art and will therefore not be disclosed in detail here.

While a preferred embodiment has been set forth above, those skilled in the art who have reviewed the present disclosure will readily appreciate that other embodiments can be realized within the scope of the invention. For example, recitations of specific hardware, software, or other technologies are illustrative rather than limiting, as any suitable hardware, software, or other technologies could be used instead. Also, the invention is not limited to smartphones, as the invention could be implemented for any other suitable devices, existing now or later developed. Therefore, the invention should be construed as limited only by the appended claims.

I claim:

1. A method for providing augmented reality to a plurality of users, the method comprising:
(a) receiving user data from the plurality of users, the user data for each of the users comprising image data taken at a location of each of the plurality of users;
(b) maintaining a database of feature points;
(c) locating feature points in the user data;
(d) matching the feature points in the user data to the database of feature points;
(e) determining augmented reality data for each of the plurality of users in accordance with said matching; and
(f) transmitting the augmented reality data for each of the plurality of users to said each of the plurality of users.

2. The method of claim 1, further comprising:
(g) determining whether any of the feature points located in step (c) are not in the database of feature points; and
(h) updating the database of feature points in accordance with the determination in step (g).

3. The method of claim 1, wherein the image data comprise video data.

4. The method of claim 1, wherein the user data further comprise location data.

5. The method of claim 4, wherein the location data comprise data global positioning system data.

6. The method of claim 4, wherein the user data further comprise user bearing data.

7. The method of claim 6, wherein the user bearing data comprise compass data.

8. The method of claim 6, wherein the user bearing data comprise accelerometer data.

9. A system for providing augmented reality to a plurality of users, the system comprising:
a communication component for electronically communicating with the plurality of users; and
a server, in electronic communication with the communication component, the server being configured for:
(a) receiving user data from the plurality of users, the user data for each of the users comprising image data taken at a location of each of the plurality of users;
(b) maintaining a database of feature points;
(c) locating feature points in the user data;
(d) matching the feature points in the user data to the database of feature points;
(e) determining augmented reality data for each of the plurality of users in accordance with said matching; and
(f) transmitting the augmented reality data for each of the plurality of users to said each of the plurality of users.

10. The system of claim 9, wherein the server is further configured for:
(g) determining whether any of the feature points located in step (c) are not in the database of feature points; and
(h) updating the database of feature points in accordance with the determination in step (g).

11. The system of claim 9, wherein the server is configured such that the image data comprise video data.

12. The system of claim 9, wherein the server is configured such that the user data further comprise location data.

13. The system of claim 12, wherein the server is configured such that the location data comprise data global positioning system data.

14. The system of claim 12, wherein the server is configured such that the user data further comprise user bearing data.

15. The system of claim 14, wherein the server is configured such that the user bearing data comprise compass data.

16. The system of claim 14, wherein the server is configured such that the user bearing data comprise accelerometer data.

17. An article of manufacture for providing augmented reality to a plurality of users, the article of manufacture comprising:
a computer-readable storage medium; and
code stored on the computer-readable storage medium, the code, when executed on a server, controlling the server for:
(a) receiving user data from the plurality of users, the user data for each of the users comprising image data taken at a location of each of the plurality of users;
(b) maintaining a database of feature points;
(c) locating feature points in the user data;
(d) matching the feature points in the user data to the database of feature points;
(e) determining augmented reality data for each of the plurality of users in accordance with said matching; and
(f) transmitting the augmented reality data for each of the plurality of users to said each of the plurality of users
